(19) United States
(12) Patent Application Publication
(10) Pub. No.: US 2021/0080338 A1
(43) Pub. Date: Mar. 18, 2021

(54) CAPACITIVE LIQUID LEAK SENSOR

(71) Applicant: Beak Myeong SEONG, Seongnam-si (KR)

(72) Inventor: Beak Myeong SEONG, Seongnam-si (KR)

(21) Appl. No.: 17/022,798

(22) Filed: Sep. 16, 2020

(30) Foreign Application Priority Data
Sep. 16, 2019 (KR) 10-2019-0113299
Mar. 4, 2020 (KR) 10-2020-0027323

(51) Int. Cl. G01M 3/18; G01N 27/22; C09D 11/033; C09D 11/52; C01B 32/198

(52) U.S. Cl. CPC G01M 3/181; G01N 27/227; C01B 32/198; C09D 11/033; C09D 11/52; G01N 27/226

(57) ABSTRACT

The present disclosure relates to a liquid leak sensor and, more particularly, to a liquid leak sensor for preventing damage to metallic electrodes attributable to a chemical solution, which are formed to detect the state of a leaking liquid on the top surface of a film. The liquid leak sensor includes a lower film in which at least one pair of metallic electrodes are formed on a top surface thereof in parallel at an interval in order to detect a leaking liquid, and a graphene ink layer coated to cover the electrodes. The graphene ink layer is formed by mixing graphene of 5 to 10 wt %, a binder of 30 to 50 wt %, 2-ethoxy ethanol of 20 to 25 wt %, DPGDME of 20 to 25 wt %, and a dispersant 5 to 10 wt % and then printing the mixture on the electrodes using graphene ink fabricated by high-pressure dispersion.

### BACKGROUND

### 1. Technical Field

The present disclosure relates to a liquid leak sensor, and more particularly, to a liquid leak sensor for preventing damage to a metallic electrode attributable to a leaking chemical solution.

### 2. Related Art

Korean Patent No. 10-1983662 (entitled “Capacitive oil detection sensor”) issued to this applicant has a structure for detecting leaking oil and an organic solvent. As illustrated in FIGS. 1 to 4, the structure has a “structure including a casing 100, a cable 102 drawn from the casing 100, for supplying a power source, a connector 103 installed at the end of the cable 102, and a sensing unit 200 provided at the bottom of the casing 100 and having a capacitive sensing pattern 210 having capacitance formed therein by leaking oil.”

Furthermore, the sensing pattern 210 includes a pair of conductive lines 211 and 212 formed on a top surface of a PCB 214. Each of the pair of conductive lines 211 and 212 is branched into multiple conductive lines. The branched conductive lines are alternately disposed at given intervals.

Furthermore, the sensing pattern 210 includes a copper layer 215 formed on the top surface of the PCB 214. A nickel-copper layer 216 is formed on the top surface of the copper layer 215. The conductive lines 211 and 212 plated with gold are stacked and formed on a top surface of the nickel-copper layer 216.

Accordingly, when water or oil is introduced into the sensing pattern, water, oil, and an organic solvent can be determined based on a change in a capacitance value.

However, the capacitive oil detection sensor according to such a conventional technology has excellent conductivity because the sensing pattern 210 is made of a conductive metal material, such as copper, nickel, or gold, but has problems in that the number of repeated uses is limited and an error of a detection signal attributable to corrosion frequently occurs if the capacitive oil detection sensor comes into contact with a chemical solution, such as an alkali solution or an acid solution.

### PRIOR ART DOCUMENT

1. Korean Patent No. 10-1983662

(Capacitive oil detection sensor)

### SUMMARY

Various embodiments are directed to the provision of a capacitive liquid leak sensor, which can protect an electrode so that the electrode is not damaged and maintain high conductivity by coating a conductive line forming a metallic sensing pattern, that is, the electrode, with graphene ink in order to prevent a chemical substance and the electrode directly come into contact with each other.

According to an embodiment, a capacitive liquid leak sensor including a casing, a cable drawn from the casing for supplying a power source, a connector installed at an end of the cable, and a sensing unit provided on a bottom of the casing and configured with a plurality of metallic electrodes so that capacitance is formed by leaking oil includes a graphene ink layer coated to cover the plurality of electrodes. The graphene ink layer is formed by mixing graphene of 5 to 10 wt %, a binder of 30 to 50 wt %, 2-ethoxy ethanol of 20 to 25 wt %, DPGDME of 20 to 25 wt %, and a dispersant of 5 to 10 wt % and then printing the mixture on the electrodes using graphene ink fabricated by high-pressure dispersion.

### BRIEF DESCRIPTION OF THE DRAWINGS

FIGS. 1 to 4 are diagrams illustrating the structure of a capacitive liquid leak sensor according to a conventional technology.

FIG. 5 is a diagram illustrating a structure in which a graphene ink layer is coated on an electrode that forms a sensing pattern.

FIG. 6 is a diagram illustrating another form of the electrode.

FIG. 7 is a diagram illustrating positively charged and reduced graphene oxide coated on a surface of the electrode.

FIG. 8 is a diagram illustrating a charge distribution when a known cable sensor comes into contact with a toxic substance.

FIG. 9 is a diagram illustrating a charge distribution when a detection line including charged and reduced graphene oxide according to another embodiment of the present disclosure comes into contact with a toxic substance.

FIG. 10 is a diagram illustrating an initial charge distribution of a detection line including charged and reduced graphene oxide, which is applied to an embodiment of the present disclosure.

FIG. 11 is a diagram illustrating a charge distribution when a known cable sensor comes into contact with a toxic substance.

FIG. 12 is a diagram illustrating a charge distribution when a detection line including charged and reduced graphene oxide according to another embodiment of the present disclosure comes into contact with a toxic substance.

### DESCRIPTION OF REFERENCE NUMERALS

210: sensing pattern
211, 212: electrode
300: graphene ink layer

### DETAILED DESCRIPTION

The aforementioned objects, characteristics, and merits are described in detail with reference to the accompanying drawings, and thus a person having ordinary skill in the art to which the present disclosure pertains may readily practice the technical spirit of the present disclosure.

In describing the present disclosure, a detailed description of a known art related to the present disclosure will be omitted if it is deemed to make the gist of the present disclosure unnecessarily vague.

Common terms which are now widely used are selected as terms used in the present disclosure by taking into consideration functions in the present disclosure, and the terms may be different depending on an intention of a technician skilled in the art, a precedent, or the advent of a new technology.

Furthermore, in a specific case, some terms are randomly selected by the applicant. In this case, the meaning of a corresponding term will be described in detail in a descriptive part of a corresponding invention.

Accordingly, terms used in the present disclosure should not be simply defined based on their names, but should be defined based on their substantial meanings and contents over the present disclosure.

Hereinafter, embodiments of the present disclosure are described in detail with reference to the accompanying drawings.

However, the embodiments of the present disclosure may be modified in various other forms, and the scope of the present disclosure is not limited to the following embodiments.

The embodiments of the present disclosure are provided to a person having ordinary knowledge in the art to more fully describe the present disclosure.

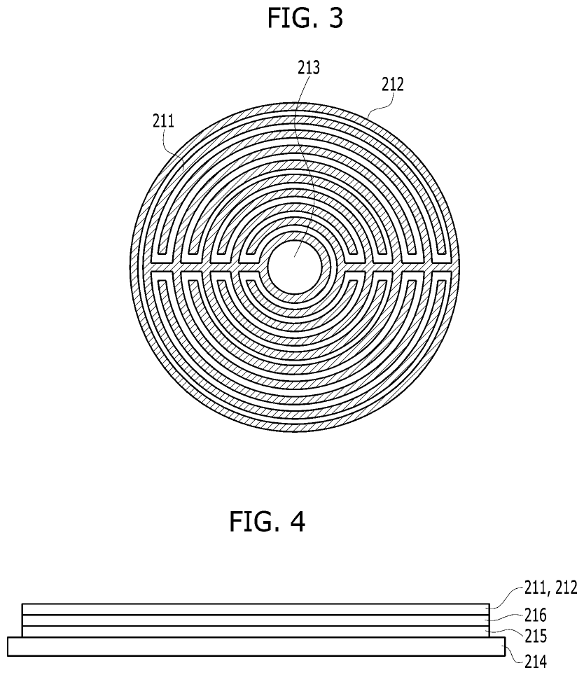

FIG. 5 is a diagram illustrating a structure in which a graphene ink layer is coated on an electrode that forms a sensing pattern.

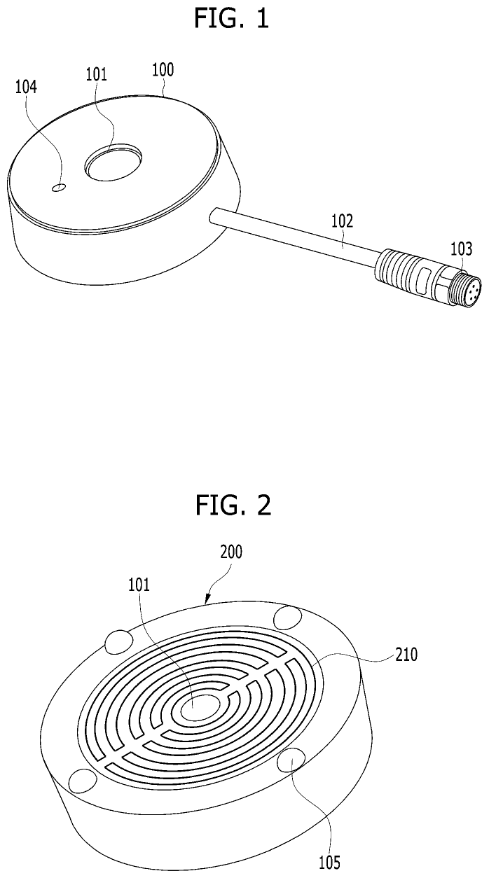

Basic structures according to an embodiment of the present disclosure, that is, structures of the casing 100, the cable 102, the connector 103, and the sensing unit 200 having the sensing pattern 210 as illustrated in FIGS. 1 and 2, are the same or similar. Accordingly, the structure of a graphene ink layer 300 for isolating metallic electrodes 211 and 212 forming the sensing pattern 210 through coating is basically described.

The sensing pattern 210 formed to be exposed from the bottom surface of the casing 100 to a lower portion is formed on the top surface of a PCB 214. Graphene ink layers 310 and 320 are printed on the electrodes 211 and 212 forming the sensing pattern 210, respectively, to a thickness of 1 to 2 μm using a print method. A leaking liquid, such as water, a chemical solution, oil, or an organic solvent introduced between the electrodes 211 and 212, does not directly come into contact with the electrodes 211 and 212. Accordingly, the electrodes 211 and 212 can be protected against oxidization or damage.

In an embodiment of the present disclosure, the electrodes 211 and 212 may have a form in which different types of metal are stacked as in a conventional technology. As another form, the electrodes 211 and 212 may be formed using single metal, such as copper, nickel, silver or gold, without stacking different types of metal.

The graphene ink layer 300 has higher resistance than the electrodes 211 and 212 made of metal, but has very low resistance because it is printed on the electrodes 211 and 212 to a very thin thickness.

That is, a leaked and introduced liquid and the electrodes 211 and 212 have an interval corresponding to the thickness of the graphene ink layer 300. Accordingly, resistance of the graphene ink layer 300 is almost negligible.

Accordingly, if a liquid, such as a leaked acid, alkali, oil, or organic solvent, is to be detected using a capacitance method, the electrodes 211 and 212 are protected against a chemical solution. As an application example of another form, if the state of a conductive leaking liquid, such as water, acid or an alkali, is to be detected based on a change in electrical conductivity or a change in a resistance value occurring due to the leaking liquid between the two electrodes 211 and 212, the graphene ink layer 300 conducts a power source, applied to the electrodes 211 and 212, to the leaking liquid. Accordingly, the state of the leaking liquid and the type of leaking liquid can be determined based on a change in electrical conductivity or a resistance value.

The graphene ink layer 300 is fabricated in a form of graphene ink which may be printed by graphene having conductivity and then coated on the electrodes 211 and 212. The graphene ink is fabricated in an ink form by mixing graphene of 5 to 10 wt %, a binder of 30 to 50 wt %, 2-ethoxy ethanol of 20 to 25 wt %, diropylene glycol dimethylether (DPGDME) of 20 to 25 wt %, and a dispersant 5 to 10 wt %, stirring the mixture, and the dispersing the mixture at high pressure.

In this case, fluorine resin having an acid-resistant property and a chemical-resistant property is used as the binder. The 2-ethoxy ethanol is mixed as a solvent. The DPGDME is mixed as a delayed solvent.

If such a mixture is dispersed at high pressure, heat is generated, and the viscosity of graphene ink is increased due to fast volatilization. At this time, the viscosity needs to be maintained by delaying the volatilization.

Accordingly, the graphene ink may have uniform viscosity even after the high-pressure dispersion by delaying the volatilization through the DPGDME.

Furthermore, for the fast hardening of the fluorine resin, after the high-pressure dispersion, the hardener corresponding to 17 to 23 wt % of the fluorine resin, that is, 5.1 to 11.5 wt % of the total graphene ink, may be additionally input.

The fabricated graphene ink is coated to fully cover the electrodes 211 and 212 using a print method so that the electrodes 211 and 212 are not exposed to the outside. The graphene ink layers 310 and 320 are not coupled.

In order to increase the conductivity of the graphene ink layer 300, silver ink may be mixed. The silver ink of 40 to 60 wt % may be mixed with the graphene ink of 40 to 60 wt %. The silver ink is configured with silver powder of 15 to 25 wt %, the binder of 40 to 60 wt %, and the DPGDME of 20 to 30 wt % mixed with respect to 40 to 60 wt % of the silver ink.

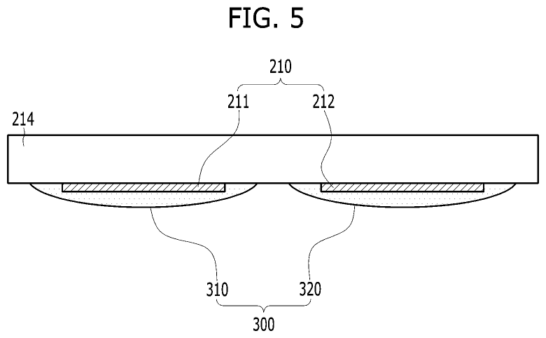

Furthermore, as illustrated in FIG. 6, the electrodes 211 and 212 may include the electrode 211 having a circle form and the electrode 212 having a ring form. The electrode 211 may also be formed in a ring form.

Compositions for electrodes including graphene oxide are coated on the electrodes 211 and 212, respectively. Accordingly, the composition has a chemical-resistant property, a drug-tolerance property, a chemical-resistant property and a drug-tolerance property and is used as an electrode. One electrode is formed as an electrode coated with a composition for an electrode including positively charged and reduced graphene oxide. The other electrode is formed as an electrode coated with a composition for an electrode including negatively charged and reduced graphene oxide.

In an embodiment of the present disclosure, graphene is used as the composition for an electrode. Graphene is a two-dimensional carbon sheet configured with carbon atoms, and shows a wide specific surface area, excellent heat conductivity, and a fast electron migration characteristic compared to the existing nano material.

Graphene may be physically separated layer by layer. Such a method is not suitable for mass production, and makes it impossible to fabricate large area graphene. Another method is a chemical peeling-off method for graphite, that is, a manufacturing process using an oxidation process. If such a method is used, a manufacturing cost is reduced, mass production is possible, and graphene oxide that allows various applications can be obtained because generated graphene is functionalized.

The graphene oxide may have a smaller number of layers than graphene using a physical method.

Several functional groups, such as an epoxy group, a hydroxyl group, a carbonyl group, and a carboxy group, are present on a surface of the graphene oxide obtained through the oxidation process.

In an embodiment of the present disclosure, in order to use the graphene oxide as an element of the electrode, the graphene oxide is reduced and used as reduced graphene oxide (rGO).

In particular, according to an embodiment of the present disclosure, when the reduced graphene oxide is fabricated, the reduced graphene oxide having a polarity is used. In this case, the sensitivity of a capacitive sensor can be significantly improved.

The liquid leak sensor according to an embodiment of the present disclosure may be fabricated by performing the steps of coating one electrode with a composition for an electrode including positively charged and reduced graphene oxide, coating the other electrode with a composition for an electrode including negatively charged and reduced graphene oxide, and performing hardening.

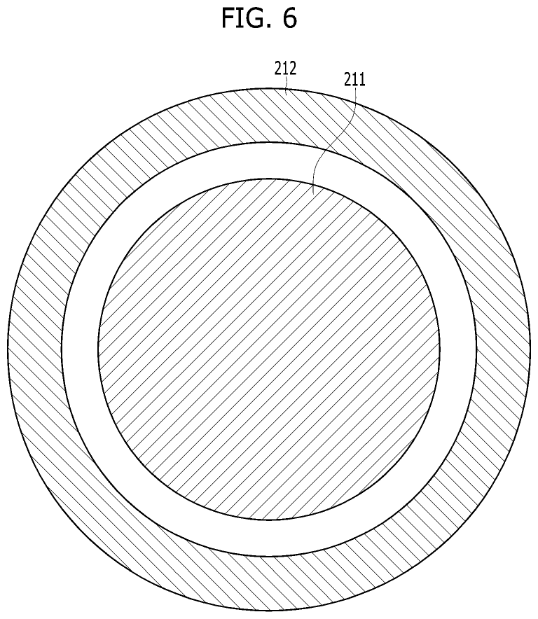

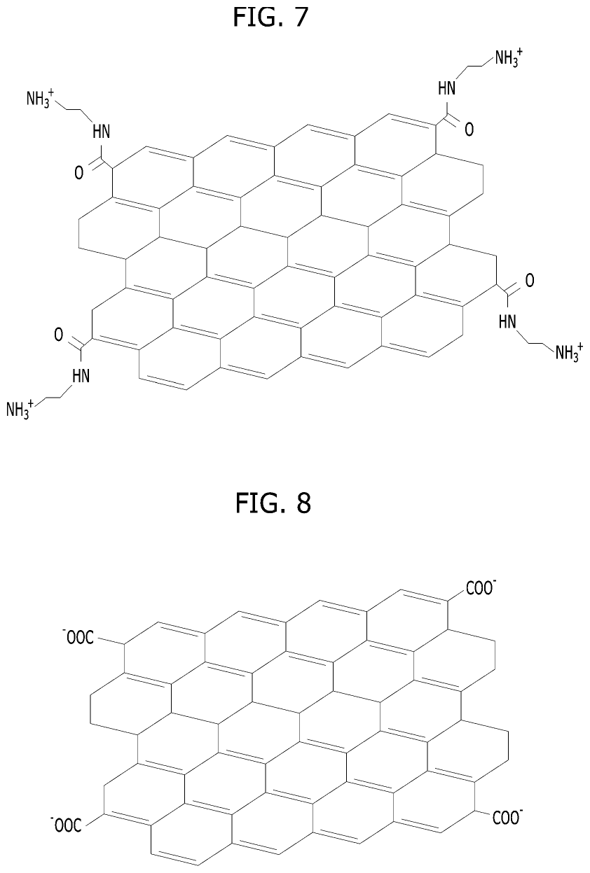

FIG. 7 is a diagram illustrating positively charged and reduced graphene oxide. FIG. 8 is a diagram illustrating negatively charged and reduced graphene oxide. In the composition for an electrode according to an embodiment of the present disclosure, the charged and reduced graphene oxide is used in the electrode.

Reduction graphene which may be obtained by reducing graphene oxide may be used as an electrode because it has conductivity unlike insulating graphene oxide.

In an embodiment of the present disclosure, in particular, positively charged and reduced graphene oxide or negatively charged and reduced graphene oxide, among reduced graphene oxides, is used.

The positively charged and reduced graphene oxide may have surface charges represented by an NH3⁺ functional group (FIG. 7). The negatively charged and reduced graphene oxide may have surface charges represented by a COO⁻ functional group (FIG. 8).

The reduced graphene oxide having the NH3⁺ functional group or the COO⁻ functional group may be obtained by reducing graphene oxide with the NH3⁺ functional group or the COO⁻ functional group left when the graphene oxide is reduced.

If the reduced graphene oxide is charged, a value of a change in capacitance related to the sensitivity of a sensor is affected.

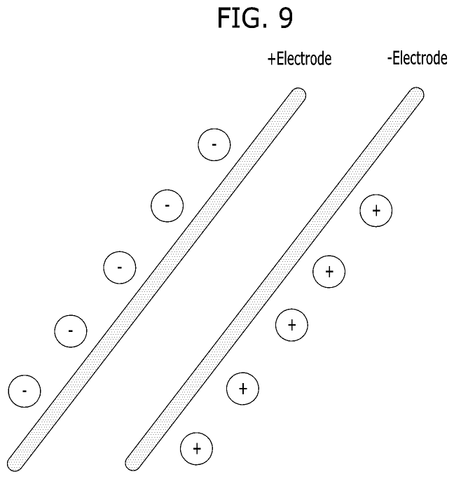

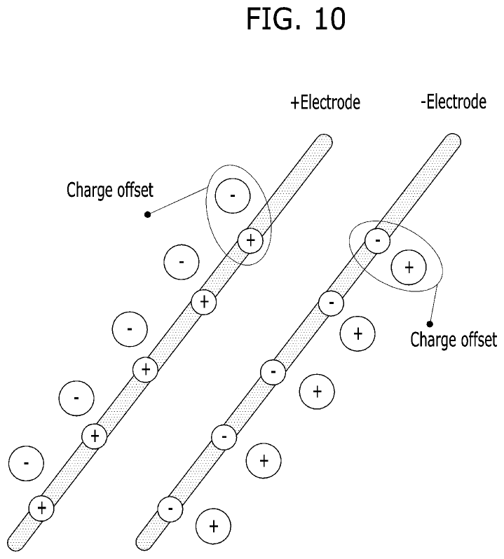

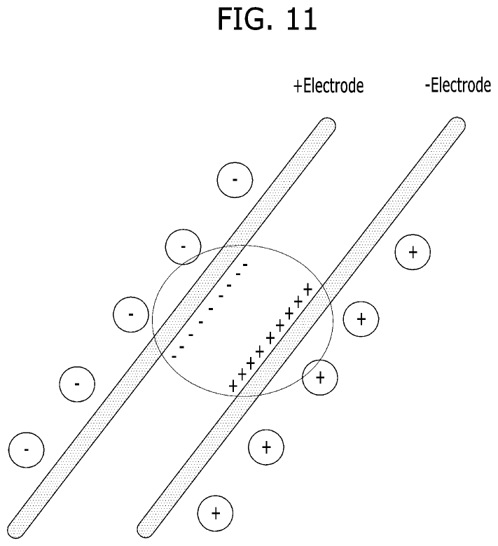

FIG. 9 is a diagram illustrating an initial charge distribution of a known sensor. FIG. 10 is a diagram illustrating an initial charge distribution of a detection line including charged and reduced graphene oxide, which is applied to an embodiment of the present disclosure. FIG. 11 is a diagram illustrating a charge distribution when a known cable sensor comes into contact with a toxic substance.

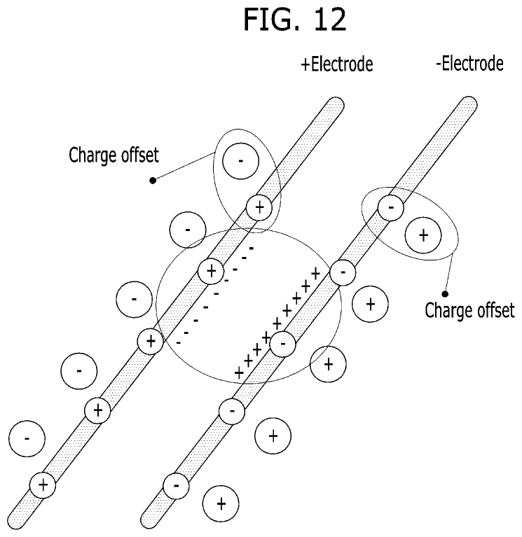

Furthermore, FIG. 12 is a diagram illustrating a charge distribution when a detection line including charged and reduced graphene oxide according to another embodiment of the present disclosure comes into contact with a toxic substance.

Referring to FIG. 9, if a conventional electrode does not include a substance having a polarity, charges are distributed to a + electrode and a − electrode, so an initial charge quantity value can be obtained.

FIG. 10 illustrates the state in which a voltage has been applied, if charged and reduced graphene oxide is coated on an electrode, that is, if positively charged and reduced graphene oxide is coated on one electrode (an upper electrode or a lower electrode) used as a + electrode and negatively charged and reduced graphene oxide is coated on the other electrode (the lower electrode or the upper electrode) used as a − electrode.

When the positively charged and reduced graphene oxide is coated on the + electrode, an initial charge quantity value is lowered because − charges induced by the application of the voltage is offset by the positively charged and reduced graphene oxide.

Referring to FIGS. 11 and 12, if the electrode of a conventional cable sensor does not have a polarity and charged and reduced graphene oxide is coated on the electrode, when the electrode is exposed to a toxic substance, the toxic substance depends on a charge quantity value. Accordingly, current charge quantity values in both cases are similar because the charge quantity values based on the same toxic substance are the same.

Since capacitance depends on the amount of charges, a change in capacitance depends on a difference between a current charge quantity and an initial charge quantity. Accordingly, assuming that a value of the current charge quantity is the same when a value of the initial charge quantity is reduced, a change in the capacitance value is increased, and thus resolution and sensitivity of the cable type liquid leak sensor are improved.

That is, if the charged and reduced graphene oxide is added to the composition for an electrode as in an embodiment of the present disclosure, the amount of charges is affected. Accordingly, the sensitivity of the cable type liquid leak sensor that functions as a capacitive according to an embodiment of the present disclosure can be improved.

A composition for a capacitive toxic substance electrode applied to an embodiment of the present disclosure includes a charged and reduced graphene oxide, a binder, a solvent, and a hardener.

Furthermore, the composition for a capacitive toxic substance electrode according to an embodiment of the present disclosure may further include a dispersant and a volatilization retardant for increasing the dispersibility of charged and reduced graphene oxide.

The binder, which may be used in the composition for a capacitive toxic substance electrode according to an embodiment of the present disclosure, may include ethylcellulose, polyvinylalcohol, polyvinylpyrrolidone, polyvinylbutyral, poly(methylmetacrylate), polyurethane or polyester, but oil-based fluorine resin may be most preferred for a high acid-resistant property.

The solvent, which may be used in the composition for a capacitive toxic substance electrode according to an embodiment of the present disclosure, may include 2-ethoxyethanol, ethanol, methanol, toluene, xylene or methyl ethyl ketone.

The dispersant, which may be used in the composition for a capacitive toxic substance electrode applied to an embodiment of the present disclosure, may include Solspers 20000, Solspers 38500, and BYK 170.

The volatilization retardant, which may be used in the composition for a capacitive toxic substance electrode according to an embodiment of the present disclosure, may include butyl carbitol acetate and dipropylene glycol dimethyl ether.

The hardener, which may be used in the composition for a capacitive toxic substance electrode according to an embodiment of the present disclosure, may include any one of BENZOYL PEROXIDE, AZOBISISOBUTYRONITRILE, 2-CYANO-2-PROPYLAZOFORMAMIDE, 2, 2-AZOBIS(2, 4-DIMETHYLVALERONITRILE, (2, 2-AZOBIS[2-(2-IMIDAZOLIN-2-YL)PROPANE]), and (2, 2-AZOBIS(2-METHYLBUTYRONITRILE). Among them, (2, 2-AZOBIS(2, 4-DIMETHYLVALERONITRILE) is mot preferred.

The composition for a capacitive toxic substance electrode, which is applied to an embodiment of the present disclosure, may be fabricated by performing the steps of mixing the charged and reduced graphene oxide, the binder, the solvent, the dispersant, and the volatilization retardant, primarily dispersing the mixture by stirring the mixture using a homomixer and secondarily dispersing the primarily dispersed mixture using a high pressure disperser, and inputting the hardener to the dispersed mixture.

The hardening may be completed at a hardening temperature of 180° C. after preliminary hardening at 100° C.

The step of primarily dispersing the mixture is the step of mixing the charged and reduced graphene oxide and oil-based fluorine resin with the solvent, which maximizes a capacitance reaction width, and may be performed for one or two hours at 5,000 to 7,000 rpm.

The step of secondarily dispersing the primary mixture using the high pressure disperser increases the coating property and dispersibility of the composition for a capacitive toxic substance electrode by smashing and dispersing the primary mixture in a high pressure state.

The secondary dispersing may be performed 5 times to 10 times under pressure of 300 to 350 bar.

The hardener is added to the dispersed mixture, and the mixture is stirred using the homomixer at 3,000 to 5,000 rpm for 10 to 30 minutes.

The charged and reduced graphene oxide of 5 to 20 wt %, the binder of 30 to 60 wt %, the solvent of 30 to 50 wt %, the hardener of 20 to 60 wt %, and the dispersant of 5 to 20 wt % may be included with respect to a total weight of the composition for a capacitive toxic substance electrode.

The capacitive liquid leak sensor according to an embodiment of the present disclosure can prevent damage to metallic electrodes and also maintain high conductivity because graphene ink is coated on the metallic electrodes forming the sensing pattern and thus leaked oil and a leaked chemical solution do not directly come into contact with the metallic electrodes.

Accordingly, the liquid leak sensor according to an embodiment of the present disclosure has an advantage in that it can be used several times or semi-permanently.

Specific parts of the contents of the present disclosure have been described above. Such detailed descriptions are merely preferred embodiments for those having ordinary knowledge in the art, and it will be evident that the scope of the present disclosure is not restricted by the detailed descriptions.

Accordingly, it may be said that a substantial scope of the present disclosure is defined by the accompanying claims and equivalents thereof.

What is claimed is:

1. A capacitive liquid leak sensor comprising a casing, a cable drawn from the casing for supplying a power source, a connector installed at an end of the cable, and a sensing unit provided on a bottom of the casing and configured with a plurality of metallic electrodes so that capacitance is formed by leaking oil, the capacitive liquid leak sensor comprising:
a graphene ink layer coated to cover the plurality of electrodes.

2. The capacitive liquid leak sensor of claim 1, wherein the graphene ink layer is formed by mixing graphene, a binder, 2-ethoxy ethanol, diropylene glycol dimethylether (DPGDME), and a dispersant and then printing the mixture on the electrodes using graphene ink fabricated by high-pressure dispersion.

3. The capacitive liquid leak sensor of claim 2, wherein the graphene is 5 to 10 wt %, the binder is 30 to 50 wt %, the 2-ethoxy ethanol is 20 to 25 wt %, the DPGDME is 20 to 25 wt %, and the dispersant is 5 to 10 wt %.

4. The capacitive liquid leak sensor of claim 2, wherein:
the graphene ink layer is formed by mixing silver ink of 40 to 60 wt % with graphene ink of 40 to 60 wt %, and
the silver ink is configured with silver powder of 15 to 25 wt %, the binder of 40 to 60 wt %, and the DPGDME of 20 to 30 wt %.

5. The capacitive liquid leak sensor of claim 2, wherein a hardener of 5.1 to 11.5 wt % is additionally added to the graphene ink.

6. The capacitive liquid leak sensor of claim 1, wherein:
one of the plurality of electrodes is configured by coating a composition for an electrode comprising positively charged and reduced graphene oxide,
the other of the plurality of electrodes is configured by coating a composition for an electrode comprising positively charged and reduced graphene oxide,
the positively charged and reduced graphene oxide is represented by surface charges having an NH3⁺ functional group, and
the negatively charged and reduced graphene oxide is represented by surface charges having a COO⁻ functional group.

7. The capacitive liquid leak sensor of claim 6, wherein each of the compositions for the electrodes comprises the charged and reduced graphene oxide of 5 to 20 wt %, a binder of 30 to 60 wt % which is oil-based fluorine resin, a solvent of 30 to 50 wt %, a hardener of 20 to 60 wt %, and a dispersant of 5 to 20 wt %.
